(19) United States
(12) Patent Application Publication
(10) Pub. No.: US 2020/0331385 A1
(43) Pub. Date: Oct. 22, 2020

(54) WARNING DISPLAY DEVICE FOR VEHICLE

(71) Applicant: Se Heon PARK, Gyeongsangbukdo (KR)

(72) Inventor: Se Heon PARK, Gyeongsangbukdo (KR)

(21) Appl. No.: 16/960,780

(22) PCT Filed: Oct. 10, 2018
(86) PCT No.: PCT/KR2018/011868

§ 371 Date: Jul. 8, 2020

(30) Foreign Application Priority Data
Jan. 9, 2018 (KR) 10-2018-0002853
Feb. 26, 2018 (KR) 10-2018-0022831

(51) Int. Cl. B60Q 1/52; B60Q 1/30; B60Q 7/00; B60R 11/00

(52) U.S. Cl. CPC B60Q 1/52; B60Q 1/30; B60R 2011/0036; B60R 11/00; B60Q 7/00

(57) ABSTRACT

The present invention relates to a warning display device for a vehicle. It is possible to prevent a warning indication part for safely guiding traffic caused by an accident, etc. to preceding or following vehicles from being exposed to the outside when not used, thereby preventing the aesthetic appearance from being deteriorated. In addition, it is possible to protect the warning display device including the warning indication part. As the warning display device is detachably coupled, it is possible to facilitate ease of maintenance.

### BACKGROUND

The present invention relates to a warning display device for a vehicle, and more particularly, to a warning display device for a vehicle, which can prevent that a warning indication part for guiding safe driving of following vehicles to prevent car accidents is exposed to the outside when not used, thereby preventing the aesthetic appearance of the vehicle from being deteriorated and protecting the warning display device including the warning indication part. In addition, as the warning display device is detachably coupled, it is possible to facilitate easy maintenance.

In general, emergency vehicles, such as police cars, fire engines, ambulances, and so on, accident vehicles or working vehicles, among vehicles driving on the road have warning lights to let vehicles and people around the emergency vehicles, accident vehicles or working vehicles know the emergency situation.

Such a warning light is fixed and mounted on a roof panel of the vehicle. In order to fix the warning light, a fixing hole is formed in the roof panel, a buffering member is located on the upper surface of the fixing hole, and then, a bracket disposed at the lower portion of the warning light is put on the upper surface of the buffering member and is fixed with a fastening bolt.

Conventionally, the warning light for a vehicle is temporarily attached to the upper surface of the roof panel when a vehicle is driven in emergency relief or in an emergency situation. So, when the warning light is not used, because it needs a place to be kept in safety and may go astray, the warning light may not cope with the emergency situations rapidly.

Moreover, the conventional warning light has a disadvantage in that it deteriorates the outward appearance of the vehicle since it is fixed on the vehicle in an exposed state.

Therefore, the conventional warning light is on the need to make improvements.

The above-mentioned technical structure is a background art to help understanding of the present invention, and does not mean a prior art well-known in the art of the present invention.

In relation with a mounting structure of a warning light for a vehicle, Korean Patent No. 10-0372439 (granted on Feb. 4, 2003) discloses a warning light device for a vehicle cargo.

### SUMMARY OF THE INVENTION

Accordingly, the present invention has been made in an effort to solve the above-mentioned problems occurring in the prior arts, and it is an object of the present invention to provide a warning display device for a vehicle, which can prevent that a warning indication part for guiding safe driving of following vehicles to prevent car accidents is exposed to the outside when not used, thereby preventing the aesthetic appearance of the vehicle from being deteriorated and protecting the warning display device by preventing the warning indication part and the warning display device from being exposed to the outside.

Another object of the present invention is to provide a warning display device for a vehicle, which can facilitate easy maintenance since being detachably combined with a vehicle body.

To achieve the above objects, the present invention provides a warning display device for a vehicle including: a base plate disposed on a vehicle body; a driving unit hinge-coupled to the base plate to be foldable; a warning indication part connected to the driving unit and rotatably reciprocating when the driving unit is operated in order to induce safe driving of forward or rearward vehicles; and a use manipulation part disposed on the vehicle body or the base plate to manipulate the driving unit and the warning indication part to be folded and to be kept in safety when they are not used and to be unfolded when they are used.

The base plate is detachably combined with the inner face of a trunk door of the vehicle body, which is exposed when being opened.

The driving unit includes: a frame rotatably extending to the base plate; a driving gear member rotatably disposed on the frame and rotatably reciprocating in both directions by external force; a driven gear member rotatably disposed on the frame and rotating by receiving rotary power from the driving gear member; and a rotary bar rotatably reciprocating in the rotational direction of the driven gear member and connecting the warning indication part.

A plurality of the warning indication parts are disposed to be slidably pushed in and drawn out and is restricted by the use manipulation part.

The use manipulation part includes: a hook lever hinge-coupled to the vehicle body or the base plate to hang and fix the warning indication part which is folded together with the driving unit; and a separation operating member disposed on the vehicle body or the base plate and operating by external force or an external signal over a set value in order to separate the hook lever from the warning indication part.

In another aspect of the present invention, the present invention provides a warning display device for a vehicle including: a housing disposed on a vehicle body and opened in one direction; a driving unit disposed on the housing; and a warning indication part connected to the driving unit and rotatably reciprocating when the driving unit is operated in order to induce safe driving of forward or rearward vehicles.

The housing is detachably combined with the ceiling of the vehicle body or the upper surface of a trunk door which is in a closed state.

The driving unit includes: a driving gear member rotatably disposed through a driving rotary shaft held on the housing and rotating in both directions by external force; a driven gear member rotatably disposed through a driven rotary shaft held on the housing and rotating by receiving rotary power from the driving gear member; and a rotary bar rotatably reciprocating in the rotational direction of the driven gear member and connecting the warning indication part.

The driven rotary shaft can change its position relative to the housing, and the warning indication part is detachably disposed on the rotary bar.

In a further aspect of the present invention, the present invention provides a warning display device for a vehicle including: a housing disposed on a vehicle body and opened in one direction; a driving unit disposed on the housing; a panel connected to the driving unit to rotatably reciprocate when the driving unit is operated; and a warning indication part indicating a warning message to the panel by an external manipulation in order to induce safe driving of forward or rearward driving vehicles.

The housing is embedded in the ceiling of the vehicle body or an open side of a trunk door, and the ceiling or the open side of the trunk door of the vehicle body is opened and closed by a cover.

The driving unit includes: a driving gear member rotatably disposed through a driving rotary shaft held on the housing and rotating in both directions by external force; a driven gear member rotatably disposed through a driven rotary shaft held on the housing and rotating by receiving rotary power from the driving gear member; and a rotary bar fixed or detachably disposed at an eccentric position of the driven gear member, rotatably reciprocating according to bidirectional rotation of the driven gear member, and connecting the warning indication part.

The housing includes a plurality of mounting hole parts penetrated to rotatably hold both sides of the driving rotary shaft, and the mounting hole parts are formed along an arc trajectory to vary the position of the driving rotary shaft.

The warning indication part includes: a laser beam part disposed on the vehicle body to irradiate a warning message along a trajectory set on the panel by an external manipulation; or a remote controller for controlling light-emitting f LED elements disposed on the panel according to the warning message with the set trajectory.

As described above, the warning display device for a vehicle according to the present invention can prevent that a warning indication part for guiding safe driving of following vehicles to prevent car accidents is exposed to the outside when not used, thereby preventing the aesthetic appearance of the vehicle from being deteriorated and protecting the warning display device by preventing the warning indication part and the warning display device from being exposed to the outside.

Additionally, the warning display device for a vehicle according to the present invention can facilitate easy maintenance since being detachably combined with a vehicle body.

### BRIEF DESCRIPTION OF DRAWINGS

FIG. 1 is a front view showing a used state of a warning display device for a vehicle according to a first preferred embodiment of the present invention.

FIG. 2 is an enlarged front view showing the used state of the warning display device for a vehicle according to the first preferred embodiment of the present invention.

FIG. 3 is a front view showing a kept state of the warning display device for a vehicle according to the first preferred embodiment of the present invention.

FIG. 4 is a side sectional view showing the kept state of the warning display device for a vehicle according to the first preferred embodiment of the present invention.

FIGS. 5 to 7 are side sectional views showing the used state of the warning display device for a vehicle according to the first preferred embodiment of the present invention.

FIG. 8 is a front view showing a used state of a warning display device for a vehicle according to a second preferred embodiment of the present invention.

FIG. 9 is a front view showing a kept state of the warning display device for a vehicle according to the second preferred embodiment of the present invention.

FIG. 10 is a side sectional view showing the used state of the warning display device for a vehicle according to the second preferred embodiment of the present invention.

FIG. 11 is a side view of the vehicle showing a used state of a warning display device for a vehicle according to a third preferred embodiment of the present invention.

FIG. 12 is an enlarged front sectional view showing the used state of the warning display device for a vehicle according to the third preferred embodiment of the present invention.

FIG. 13 is an enlarged side sectional view showing the used state of the warning display device for a vehicle according to the third preferred embodiment of the present invention.

FIG. 14 is a front sectional view showing a kept state of the warning display device for a vehicle according to the third preferred embodiment of the present invention.

FIG. 15 is an enlarged front sectional view showing a used state of a warning display device for a vehicle according to a fourth preferred embodiment of the present invention.

### DETAILED DESCRIPTION OF THE INVENTION

Hereinafter, reference will be now made in detail to preferred embodiments of a warning display device for a vehicle according to the present invention with reference to the attached drawings. In the drawings, thicknesses of lines and sizes of constituent elements may be exaggerated for clarity and convenience in explanation. In addition, the embodiment disclosed hereinafter does not limit the scope of the present invention, but corresponds to merely exemplary terms of constituent elements presented in claims of the present invention, and the embodiments that include replaceable constituent elements as equivalents of the constituent elements defined in the overall specification and claims may be included in the scope of the present invention.

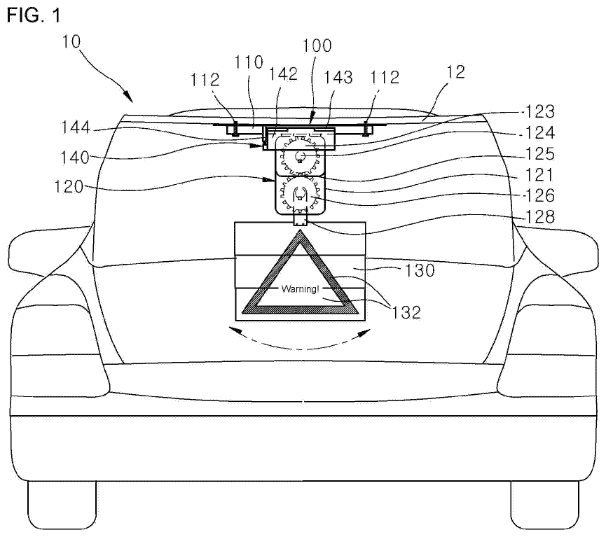

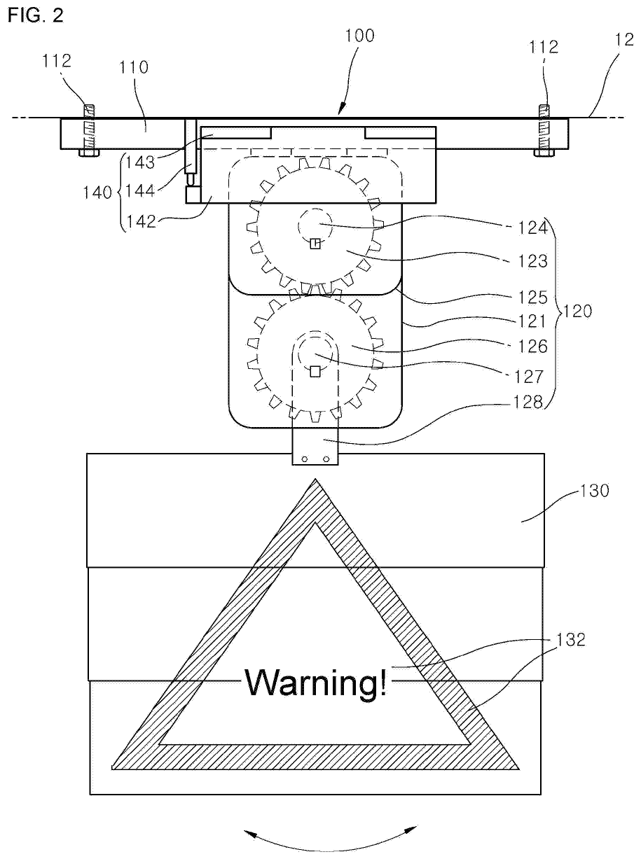

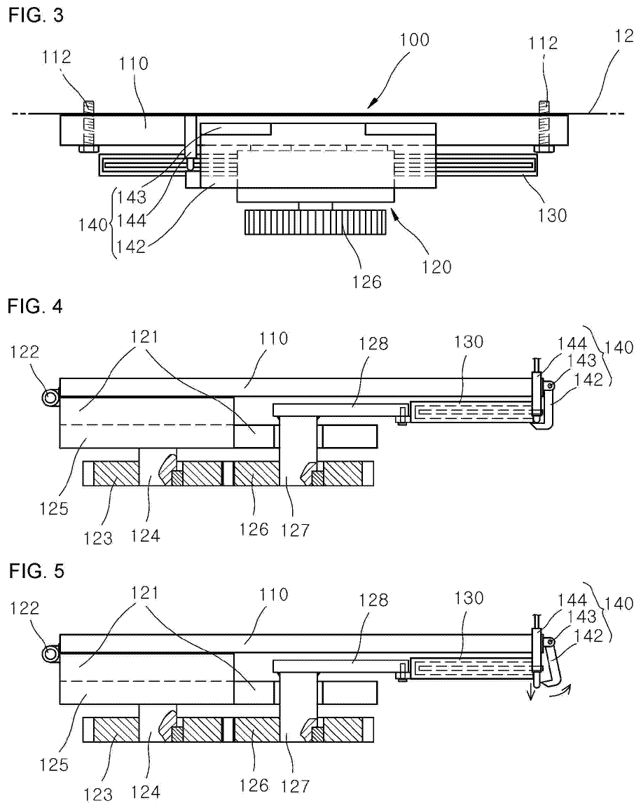

FIG. 1 is a front view showing a used state of a warning display device for a vehicle according to a first preferred embodiment of the present invention, FIG. 2 is an enlarged front view showing the used state of the warning display device for a vehicle according to the first preferred embodiment of the present invention, and FIG. 3 is a front view showing a kept state of the warning display device for a vehicle according to the first preferred embodiment of the present invention.

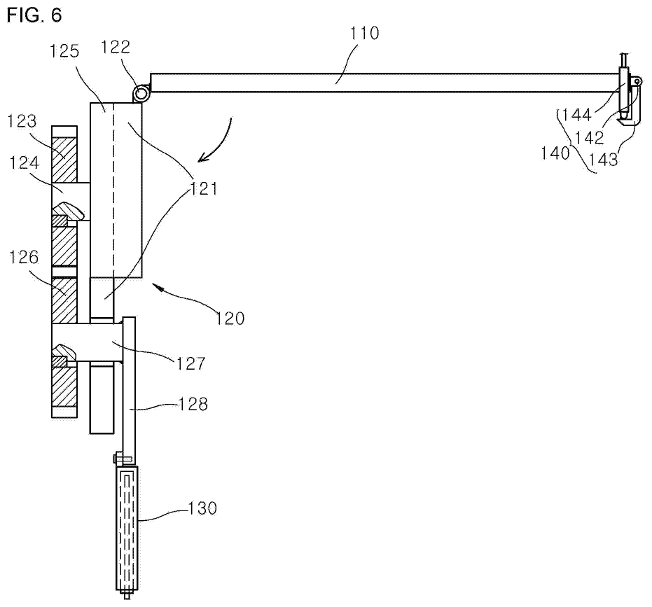

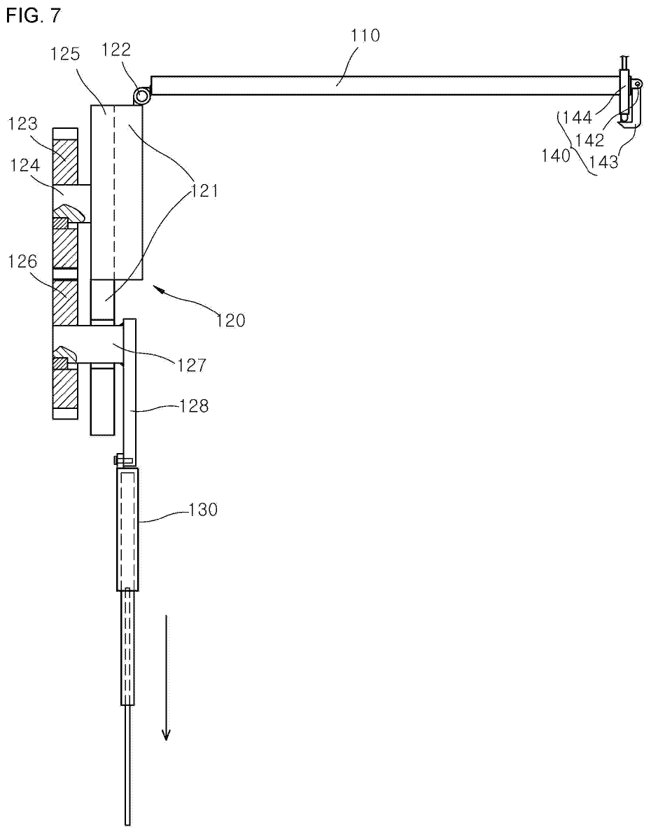

FIG. 4 is a side sectional view showing the kept state of the warning display device for a vehicle according to the first preferred embodiment of the present invention, and FIGS. 5 to 7 are side sectional views showing the used state of the warning display device for a vehicle according to the first preferred embodiment of the present invention.

Referring to FIGS. 1 to 7, the warning display device 100 for a vehicle according to the first preferred embodiment of the present invention includes a base plate 110, a driving unit 120, a warning indication part 130, and a use operation part 140.

In this instance, the warning display device 100 for a vehicle according to the first preferred embodiment of the present invention is disposed on a vehicle body 10, especially, on the inner face of a trunk door 12 of the vehicle body 10. Therefore, the warning display device 100 is exposed to following vehicles when the trunk door 12 is opened. Of course, when the trunk door 12 is in a closed state, the warning display device 100 is prevented from being exposed.

Here, the base plate 110 is disposed on the vehicle body 10. Especially, the base plate 110 is detachably combined with the inner face of the trunk door 12 exposed when the trunk door 12 of the vehicle body 10 is opened. Therefore, in the state where the trunk door 12 is closed, the warning display device 100 for a vehicle according to the first preferred embodiment of the present invention is prevented from being exposed to be protected, and enhances an aesthetic sense since the warning display device 100 is not exposed to the outside of the vehicle body 10.

In this instance, the base plate 110 is detachably combined with the inner face of the trunk door 12 by a coupling member 112. Here, the coupling member 112 is a bolt or a screw. Moreover, the driving unit 120 is connected to the base plate 110 to be able to rotate and to reciprocate rotatably.

Of course, the base plate 110 may have various shapes and may be made of various materials, and the driving unit 120 may be connected to the inner face of the trunk door 12 to be able to rotate and to reciprocate rotatably.

In the meantime, the driving unit 120 is hinge-coupled to the base plate 110 in a foldable manner, and serves to make the warning indication part 130 reciprocate rotatably.

In detail, the driving unit 120 includes a frame 121, a driving gear member 123, a driven gear member 126, and a rotary bar 128.

The frame 121 extends to the base plate 110 to be rotatable. That is, the frame 121 rotates in one direction from an edge of one side of the base plate 110 around a first hinge 122 and returns to its initial position in the opposite direction. Here, the ‘one direction’ means the direction toward the rear of the driving vehicle.

Furthermore, the driving gear member 123 is rotatably disposed on the frame 121 in the circumferential direction, and reciprocates rotatably in both directions by external force.

In other words, a driving rotary shaft 124 is inserted into a central hole of the driving gear member 123. Therefore, the driving gear member 123 rotates in the circumferential direction based on the driving rotary shaft 124. In this instance, the driving gear member 123 and the driving rotary shaft 124 may be rotated in the same direction together or only the driving gear member 123 may be rotated in the circumferential direction relative to the driving rotary shaft 124.

Especially, one side or both sides of the driving rotary shaft 124 may be rotatably inserted into the frame 121 to be held. Therefore, the driving gear member 123 may be inserted into the frame 121.

Because the driving gear member 123 is embedded in the frame 121, it can prevent a user's body part, such as a hand, from being injured by the driving gear member 123.

Of course, the frame 121 may have various shapes and various materials.

Additionally, a driving motor 125 is mounted on the frame 121. The driving motor 125 makes the driving rotary shaft 124 or the driving gear member 123 reciprocate rotatably in one direction and in the opposite direction. Of course, the driving motor 125 may be mounted on the frame 121 in various ways.

Moreover, the driven gear member 126 is rotatably disposed on the frame 121, and rotates by receiving rotary power from the driving gear member 123.

In detail, a driven rotary shaft 127 is inserted into a central hole of the driven gear member 126. Furthermore, one side or both sides of the driven rotary shaft 127 may be rotatably held on the frame 121 at corresponding positions. In this instance, the driven gear member 126 may be inserted (embedded) into the frame 121, or may be circumscribed and gear-coupled with the driving gear member 123. Therefore, the driven gear member 126 receives rotary power from the driving gear member 123.

In this instance, the driven gear member 126 and the driven rotary shaft 127 may be rotated in the same direction together, or the driven gear member 126 may be rotated relative to the driven rotary shaft 127.

The rotary bar 128 reciprocates rotatably according to the rotational direction of the driven gear member 126, and is connected to the driven gear member 126 or the driven rotary shaft 127. So, the rotary bar 128 reciprocates along an arc trajectory. Especially, the rotary bar 128 reciprocates rotatably along the center and the edge of the road.

In addition, the warning indication part 130 is connected to the rotary bar 128. Of course, the rotary bar 128 fixes the warning indication part 130 in various ways. Therefore, the warning indication part 130 reciprocates rotatably along the arc trajectory like the rotary bar 128.

Especially, the warning indication part 130 is connected to the rotary bar 128 of the driving unit 120. When the driving unit 120 is operated, the warning indication part 130 reciprocates rotatably together with the rotary bar 128 and serves to guide safe driving of forward vehicles or following vehicles. Of course, the warning indication part 130 may be varied into various shapes.

In this instance, the warning indication part 130 may include a warning light 132 emitting light. The warning light 132 may be formed along the trajectory of various characters or letters, and emits light through a power source supplied by external force or external manipulation. In detail, the warning light 132 emits light by the supplied power source when a driver manipulates a switch (not shown), or emits light in a spread state when the trunk door 12 is opened at the time of collision with another vehicle.

Especially, the warning indication part 130 is foldably disposed to reduce a flat surface area when being hung and fixed by the use operation part 140.

That is, there are a plurality of the warning indication parts 130, and the warning indication parts 130 are slidably pushed in and drawn out. Of course, the warning indication part 130 may be varied into various shapes, and the number of the warning indication parts 130 is not limited.

In the meantime, the use manipulation part 140 is disposed on the vehicle body 10 or the base plate 110, and controls the driving unit 120 and the warning indication part 130 to be folded and kept in safety when they are not used and to be unfolded when they are used. That is, the use manipulation part 140 guides the driving unit 120 and the warning indication part 130 relative to the base plate 110 to be folded and kept in safety when they are not used and to be unfolded when they are used.

In detail, the use manipulation part 140 includes a hook lever 142 and a separation operating member 144.

The hook lever 142 is hinge-coupled to the vehicle body 10 or the base plate 110 and serves to hang and fix the warning indication part 130 which is folded together with the driving unit 120.

That is, the hook lever 142 is rotatably disposed at the edge of the other side of the base plate 110 by a second hinge 143. Moreover, the hook lever 142 serves to hang and fix the warning indication part 130 folded together with the driving unit 120 toward the base plate 110. In this instance, the warning indication part 130 is caught to the hook lever 142 in a multiple-stage folded state.

Of course, the hook lever 142 may be varied into various shapes, and the number of the hook levers 142 is not limited.

Furthermore, the separation operating member 144 is disposed on the vehicle body 10 or the base plate 110, is operated by external force or an external signal above a set value, and serves to separate the hook lever 142 from the warning indication part 130.

That is, the separation operating member 144 is fixed at the edge or a border of the other side of the base plate 110, is operated by external force or an external signal above a set value, and serves to separate the hook lever 142 from the warning indication part 130 by pushing the hook lever 142. In this instance, the separation operating member 144 may be a cylinder operated in the back-and-forth direction.

Finally, in a state where the driving unit 120 and the warning indication part 130 are folded toward the base plate 110, the hook lever 142 hangs and fixes the warning indication part 130. Additionally, the trunk door 12 is in the closed state.

After that, when the vehicle body 10 collides, if an external shock over the set value is generated or the user manipulates the switch, the trunk door 12 is opened.

In link with the trunk door 12, the separation operating member 144 moves forwards and pushes the hook lever 142 to separate the hook lever 142 from the warning indication part 130. Therefore, the warning indication part 130 is unfolded and spread together with the driving unit 120 by self-load. In this instance, the separation operating member 144 returns to its original position.

In link with the above, the driving motor 125 is operated to rotate the driving gear member 123. The driven gear member 126 rotates bidirectionally in the circumferential direction, and the rotary power rotates the rotary bar 128 and the warning indication part 130 bidirectionally.

The driving motor 125 continuously operates till a signal is transferred from the outside.

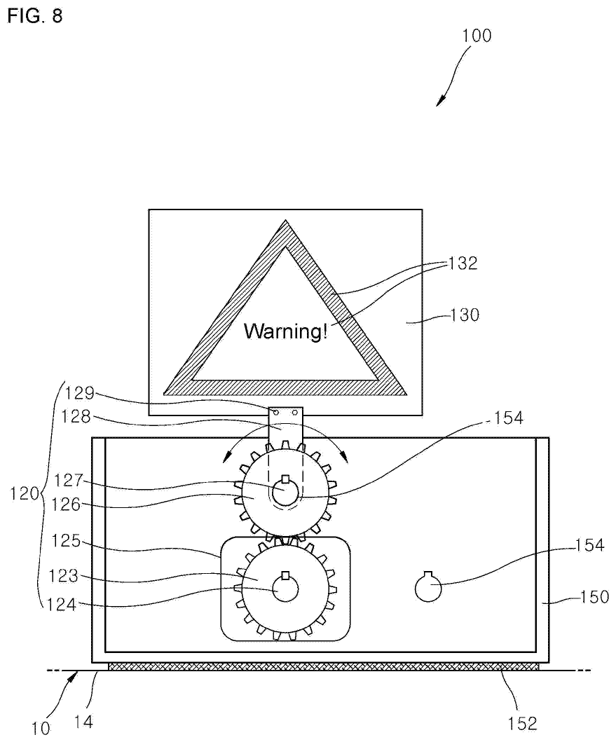

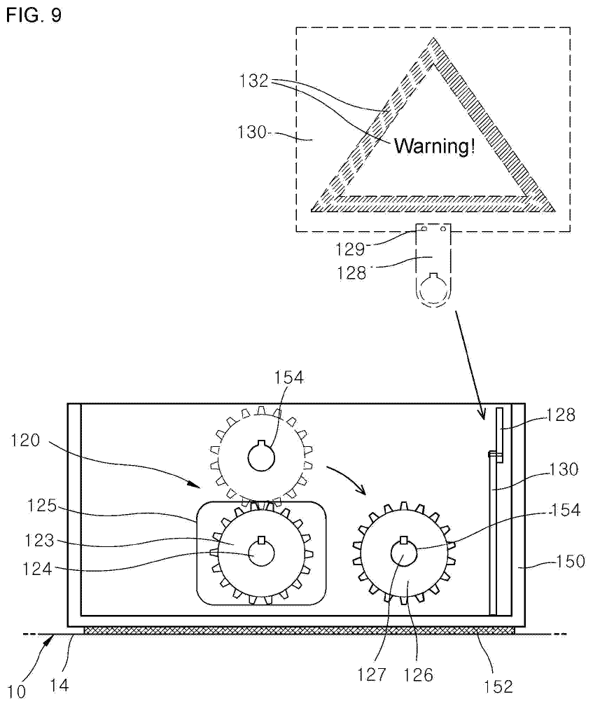

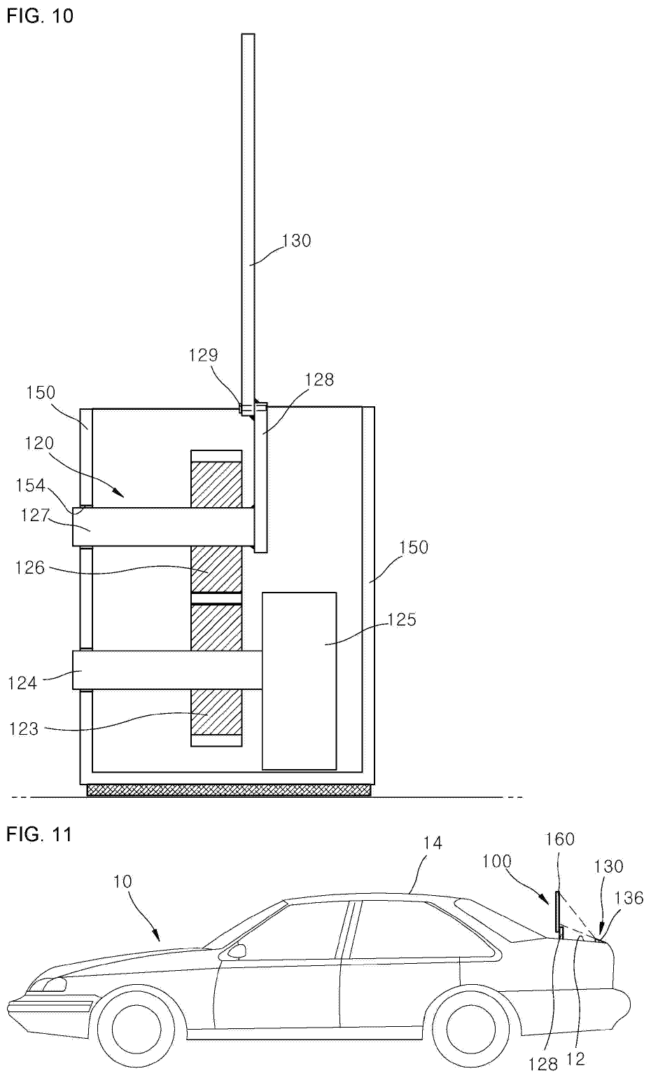

FIG. 8 is a front view showing a used state of a warning display device for a vehicle according to a second preferred embodiment of the present invention, FIG. 9 is a front view showing a kept state of the warning display device for a vehicle according to the second preferred embodiment of the present invention, and FIG. 10 is a side sectional view showing the used state of the warning display device for a vehicle according to the second preferred embodiment of the present invention.

Referring to FIGS. 8 to 10, the warning display device for a vehicle according to the second preferred embodiment of the present invention includes a housing 150, a driving unit 120, and a warning indication part 130.

The housing 150 is detachably combined with the vehicle body 10, especially, with the ceiling 14 of the vehicle body 10. That is, the housing 150 is detachably combined with the vehicle body 10 by a detachable member 152. For instance, the detachable member 152 may be attached to the ceiling 14 by a Teflon tape (Velcro tape). Of course, the housing 150 may be detachably combined with the upper surface of the trunk door (not shown) which is in the closed state.

Moreover, the housing 150 is formed to be opened upwards. Of course, the housing 150 may have various shapes and various materials.

Furthermore, the driving unit 120 is disposed inside the housing 150 to rotatably reciprocate the warning indication part 130.

Here, the driving unit 120 includes a driving gear member 123, a driven gear member 126, and a rotary bar 128.

A driving rotary shaft 124 is inserted into a central hole of the driving gear member 123. The driving rotary shaft 124 is rotatably held on the housing 150 of which one side or both sides correspond.

Additionally, the driving gear member 123 rotates in both directions by the driving motor 125.

A driven rotary shaft 127 is inserted into a central hole of the driven gear member 126. The driven rotary shaft 127 is rotatably held on the housing 150 of which one side or both sides correspond.

Therefore, the driven gear member 126 may be circumscribed and gear-coupled with the driving gear member 123. Therefore, the driven gear member 126 receives rotary power from the driving gear member 123.

The rotary bar 128 reciprocates rotatably according to the rotational direction of the driven gear member 126, and is connected to the driven gear member 126. So, when the driven gear member 126 is rotated, the rotary bar 128 and the warning indication part 130 reciprocate rotatably along an arc trajectory.

Especially, the warning indication part 130 includes a warning light 132 emitting light by the user's manipulation.

Therefore, the user can draw out the housing 150 kept in the trunk and attaches the housing 150 to the ceiling 14 at the time of an emergency inspection or a fender bender.

Moreover, when the user manipulates the switch, the driving motor 125 is operated, so that the rotary bar 128 and the warning indication part 130 reciprocate rotatably through the driving gear member 123 and the driven gear member 126.

When the situation is over, the user blocks the signal transferred to the driving motor 125, separates the housing 150 from the ceiling 14, and keeps the housing 150 in the trunk.

In this instance, if the whole height of the rotary bar 128 and the warning indication part 130 is too high, it is difficult to keep the warning display device 100 in the trunk or the place where the housing 150 is kept must be widened.

In order to prevent the above, the driven rotary shaft 127 inserted into the central hole of the driven gear member 126 can change its position relative to the housing 150. That is, the housing 150 may have two or more mounting hole parts 154 along the arc trajectory so that the driven rotary shaft 127 is held or inserted.

Therefore, the user separates the driven rotary shaft 127 from the driven gear member 126, inserts the driven rotary shaft 127 into the lowermost mounting hole part 154 and fit it to the driven gear member 126. So, the rotary bar 128 is arranged side by side with the ceiling 14.

Additionally, the warning indication part 130 is combined to be separated from the rotary bar 128 by a coupling member 129.

Therefore, the user loosens the coupling member 129 to separate the warning indication part 130 and the rotary bar 128, and then, keeps the warning indication part 130 into the housing 150.

Finally, the rotary bar 128 and the warning indication part 130 is prevented from protruding outwards from the housing 150.

In addition, the housing 150 may be covered with a cover (not shown) in order to prevent foreign matters from entering into the driving unit 120 and the warning indication part 130 when the housing 150 is kept.

The unexplained reference numerals are substituted with those described in the above embodiment.

FIG. 11 is a side view of the vehicle showing a used state of a warning display device for a vehicle according to a third preferred embodiment of the present invention.

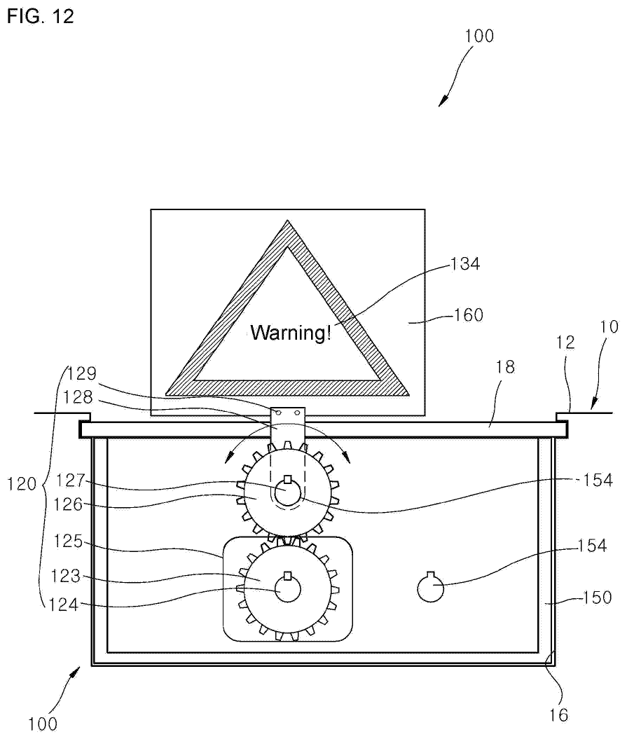

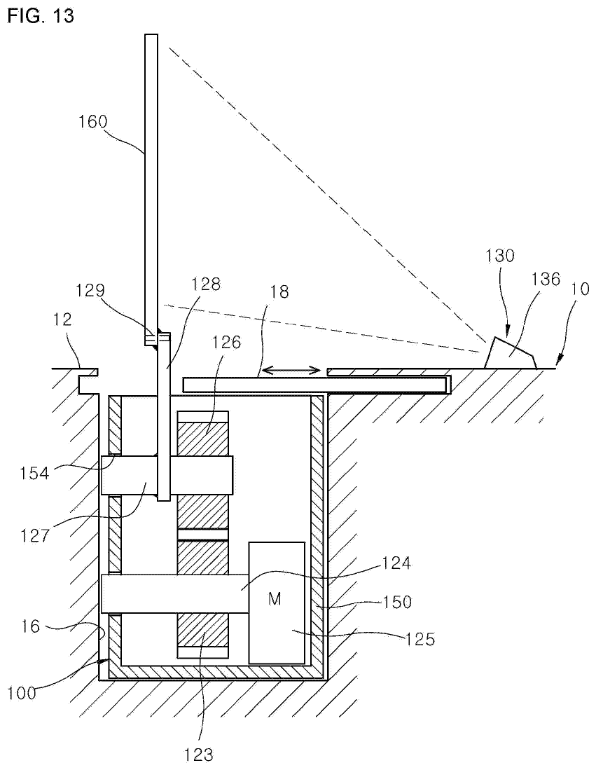

FIG. 12 is an enlarged front sectional view showing the used state of the warning display device for a vehicle according to the third preferred embodiment of the present invention, and FIG. 13 is an enlarged side sectional view showing the used state of the warning display device for a vehicle according to the third preferred embodiment of the present invention.

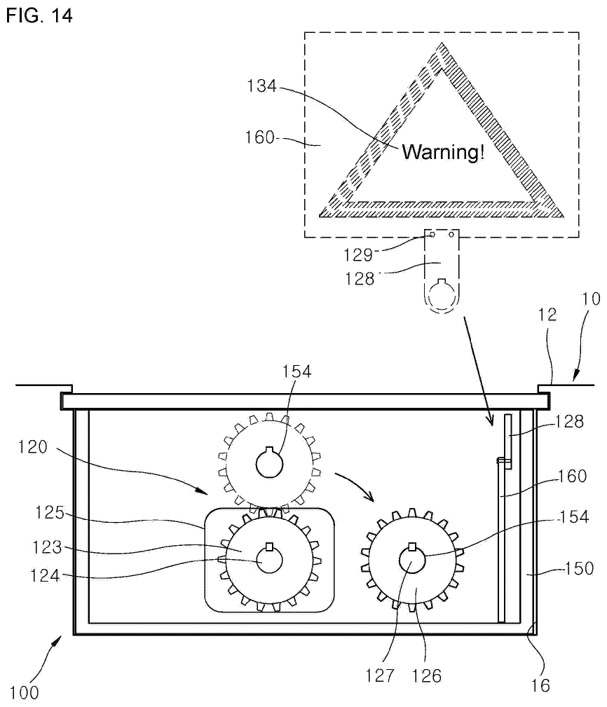

FIG. 14 is a front sectional view showing a kept state of the warning display device for a vehicle according to the third preferred embodiment of the present invention.

Referring to FIGS. 11 to 14, the warning display device 100 for a vehicle according to the third preferred embodiment of the present invention includes a housing 150, a driving unit 120, a panel 160, and a warning indication part 130.

In this instance, the warning display device 100 for a vehicle according to the third preferred embodiment of the present invention is disposed on the vehicle body 10, especially, on the trunk door 12 of the vehicle body 10. Of course, the warning display device 100 for a vehicle according to the third preferred embodiment of the present invention may be disposed on the ceiling 14 of the vehicle body 10.

The housing 150 is formed to be embedded in the trunk door 12 of the vehicle body 10. Especially, the trunk door 12 includes a dent groove part 16 opened upwards, and the housing 150 is seated in the dent groove part 16. In this instance, the housing 150 is detachably fixed and mounted in the dent groove part 16 by a bolt or Teflon tape (Velcro tape).

Moreover, the housing 150 is formed to be opened upwards. Of course, the housing 150 may have various shapes and various materials.

Furthermore, the driving unit 120 is disposed inside the housing 150 and serves to make the panel 160 reciprocate rotatably within a predetermined angle range.

That is, the panel 160 reciprocates rotatably by operation of the driving unit 120. In this instance, the panel 160 is not limited in its size, number, material, and shape.

Additionally, the warning indication part 130 indicates a warning message 134 to the panel 160 by an external manipulation in order to induce safe driving of forward or rearward driving vehicles.

In this instance, because the warning message 134 emits light and the panel 160 reciprocates rotatably, drivers of the forward or rearward driving vehicles can sufficiently secure the visual field.

Especially, the driving unit 120 includes a driving gear member 123, a driven gear member 126, and a rotary bar 128.

A driving rotary shaft 124 is inserted into a central hole of the driving gear member 123. The driving rotary shaft 124 is rotatably held on the housing 150 of which one side or both sides correspond.

Moreover, the driving gear member 123 rotates in both directions within a predetermined rotating angle range by the driving motor 125.

A driven rotary shaft 127 is inserted into a central hole of the driven gear member 126. The driven rotary shaft 127 is rotatably held on the housing 150 of which one side or both sides correspond.

Therefore, the driven gear member 126 may be circumscribed and gear-coupled with the driving gear member 123. Therefore, the driven gear member 126 receives rotary power from the driving gear member 123.

The rotary bar 128 reciprocates rotatably according to the rotational direction of the driven gear member 126, and is connected to the panel 160. So, when the driven gear member 126 is rotated, the rotary bar 128 and the panel 160 reciprocate rotatably along an arc trajectory.

Furthermore, the warning indication part 130 is disposed on the vehicle body 10, especially, on the ceiling 14 or the trunk door 12, and includes a laser beam part 136 for irradiating the warning message 134 to the panel 160 along a trajectory set by the external manipulation.

The laser beam part 136 includes a laser beam generator fixed on the ceiling 14 or the trunk door 12 to be waterproof in order to irradiate laser beam.

In this instance, the laser beam part 136 irradiates laser beam to the panel 160 along the corresponding trajectory according to information inputted from the outside. Therefore, the laser beam part 136 can irradiate various laser beams to the panel 160.

Especially, the laser beam generator of the laser beam part 136 can rotatably reciprocates in the same direction as the panel 160 depending on reciprocating rotation of the panel 160.

Moreover, the housing 150 is formed to be opened upwards since the housing 150 has to expose the panel 160 in the state where it accommodates the driving unit 120 therein.

In order to open and close the opened upper portion of the housing 150, the ceiling 14 or the trunk door 12 has a cover 18 sliding along the edge of the dent groove part 16. The cover 18 may be opened and closed manually or automatically by a cylinder.

Not shown in the drawings, but the cover 18 may have a roller which moves in rolling contact along a rail formed on the inner face of the dent groove part 16.

Therefore, the user can open the dent groove part 16 b manipulating the cover 18 at the time of an emergency inspection or a fender bender.

Moreover, when the user manipulates the switch, the driving motor 125 is operated, so that the rotary bar 128 and the panel 160 reciprocate rotatably through the driving gear member 123 and the driven gear member 126.

When the situation is over, the user blocks the signal transferred to the driving motor 125, so that the panel 160 and the rotary bar 128 are fixed.

In this instance, if the whole height of the rotary bar 128 and the panel 160 is too high, it is difficult to keep the warning display device 100 in the trunk or the place where the housing 150 is kept must be widened.

In order to prevent the above, the driven rotary shaft 127 inserted into the central hole of the driven gear member 126 can change its position relative to the housing 150. That is, the housing 150 may have two or more mounting hole parts 154 along the arc trajectory so that the driven rotary shaft 127 is held or inserted.

Therefore, the user separates the driven rotary shaft 127 from the driven gear member 126, inserts the driven rotary shaft 127 into the lowermost mounting hole part 154 and fit it to the driven gear member 126.

Additionally, the panel 160 is combined to be separated from the rotary bar 128 by a coupling member 129.

Therefore, the user loosens the coupling member 129 and separates the panel 160 and the rotary bar 128 to keep the panel 160 inside the housing 150, or separates the combined panel 160 and rotary bar 128 from the driven rotary shaft 127 and keeps them inside the housing 150.

Finally, the rotary bar 128 and the panel 160 is prevented from protruding outwards from the housing 150.

After that, when the cover 18 blocks the dent groove part 16, the warning display device 100 kept in the housing 150 is protected.

The unexplained reference numerals are substituted with those described in the above embodiments.

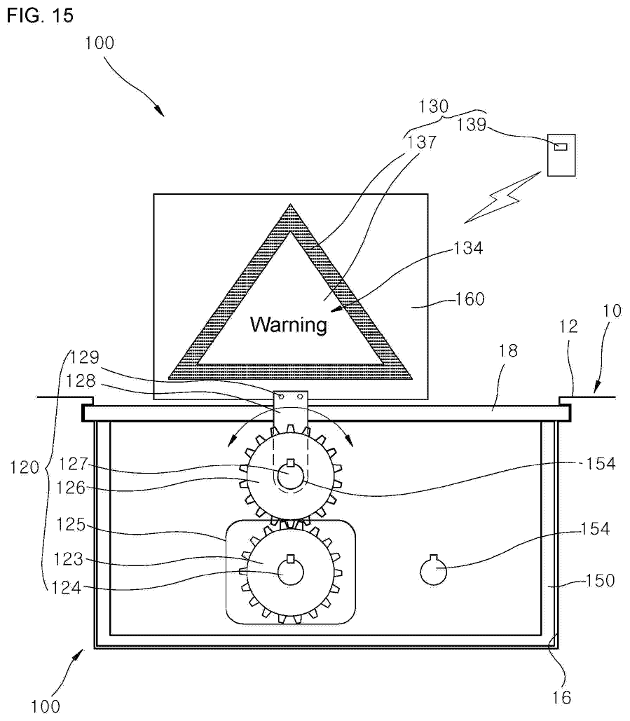

FIG. 15 is an enlarged front sectional view showing a used state of a warning display device for a vehicle according to a fourth preferred embodiment of the present invention.

Referring to FIG. 15, the warning display device 100 for a vehicle according to the fourth preferred embodiment of the present invention includes a housing 150, a driving unit 120, a panel 160, and a warning indication part 130.

The housing 150 is substituted with that described in the third embodiment.

As described above, the driving unit 120 includes a driving gear member 123, a driven gear member 126, and a rotary bar 128.

Moreover, the warning indication part 120 indicates a warning message 134 on the panel 160 by an external manipulation in order to induce safe driving of forward vehicles or backward driving vehicles.

In this instance, the warning indication part 130 includes a plurality of LED elements 137 and a remote controller 139.

The plurality of LED elements 137 are disposed on the surface of the panel 160 within a range of a rectangular trajectory or a round trajectory.

Furthermore, the remote controller 139 controls the LED elements 137 corresponding to the trajectory of the set warning message 134, among the LED elements 137 disposed on the panel 160, to emit light when the user manipulates a switch or a button corresponding to the set warning message 134.

In this instance, the remote controller 139 is disposed in the vehicle to control light-emitting of the LED elements 137 by cable or wirelessly, and may be applied to a mobile communication terminal to control light-emitting of the LED elements 137 wirelessly.

The unexplained reference numerals are substituted with those described in the above embodiments.

While the present invention has been particularly shown and described with reference to exemplary embodiments thereof, it will be understood by those of ordinary skill in the art that various changes, modifications and equivalents can be made without deviating from the spirit or scope of the invention. Therefore, it is to be understood that the actual technical protection scope of the present invention must be determined by the spirit of the appended claims.

1. A warning display device for a vehicle comprising:
a base plate disposed on a vehicle body;
a driving unit hinge-coupled to the base plate to be foldable;
a warning indication part connected to the driving unit and rotatably reciprocating when the driving unit is operated in order to induce safe driving of forward or rearward vehicles; and
a use manipulation part disposed on the vehicle body or the base plate to manipulate the driving unit and the warning indication part to be folded and to be kept in safety when they are not used and to be unfolded when they are used.

2. The warning display device for a vehicle according to claim 1, wherein the base plate is detachably combined with the inner face of a trunk door of the vehicle body, which is exposed when being opened.

3. The warning display device for a vehicle according to claim 1, wherein the driving unit comprises:
a frame rotatably extending to the base plate;
a driving gear member rotatably disposed on the frame and rotatably reciprocating in both directions by external force;
a driven gear member rotatably disposed on the frame and rotating by receiving rotary power from the driving gear member; and
a rotary bar rotatably reciprocating in the rotational direction of the driven gear member and connecting the warning indication part.

4. The warning display device for a vehicle according to claim 1, wherein a plurality of the warning indication parts are disposed to be slidably pushed in and drawn out and is restricted by the use manipulation part.

5. The warning display device for a vehicle according to claim 1, wherein the use manipulation part comprises:
a hook lever hinge-coupled to the vehicle body or the base plate to hang and fix the warning indication part which is folded together with the driving unit; and
a separation operating member disposed on the vehicle body or the base plate and operating by external force or an external signal over a set value in order to separate the hook lever from the warning indication part.

6. A warning display device comprising:
a housing disposed on a vehicle body and opened in one direction;
a driving unit disposed on the housing; and
a warning indication part connected to the driving unit and rotatably reciprocating when the driving unit is operated in order to induce safe driving of forward or rearward vehicles.

7. The warning display device for a vehicle according to claim 6, wherein the housing is detachably combined with the ceiling of the vehicle body or the upper surface of a trunk door which is in a closed state.

8. The warning display device for a vehicle according to claim 6, wherein the driving unit comprises:
a driving gear member rotatably disposed through a driving rotary shaft held on the housing and rotating in both directions by external force;
a driven gear member rotatably disposed through a driven rotary shaft held on the housing and rotating by receiving rotary power from the driving gear member; and
a rotary bar rotatably reciprocating in the rotational direction of the driven gear member and connecting the warning indication part.

9. The warning display device for a vehicle according to claim 8, wherein the driven rotary shaft can change its position relative to the housing, and the warning indication part is detachably disposed on the rotary bar.

10. A warning display device for a vehicle comprising:
a housing disposed on a vehicle body and opened in one direction;
a driving unit disposed on the housing;
a panel connected to the driving unit to rotatably reciprocate when the driving unit is operated; and
a warning indication part indicating a warning message to the panel by an external manipulation in order to induce safe driving of forward or rearward driving vehicles.

11. The warning display device for a vehicle according to claim 10, wherein the housing is embedded in the ceiling of the vehicle body or an open side of a trunk door, and the ceiling or the open side of the trunk door of the vehicle body is opened and closed by a cover.

12. The warning display device for a vehicle according to claim 10, wherein the driving unit comprises:
a driving gear member rotatably disposed through a driving rotary shaft held on the housing and rotating in both directions by external force;
a driven gear member rotatably disposed through a driven rotary shaft held on the housing and rotating by receiving rotary power from the driving gear member; and
a rotary bar fixed or detachably disposed at an eccentric position of the driven gear member, rotatably reciprocating according to bidirectional rotation of the driven gear member, and connecting the warning indication part.

13. The warning display device for a vehicle according to claim 12, wherein the housing includes a plurality of mounting hole parts penetrated to rotatably hold both sides of the driving rotary shaft, and the mounting hole parts are formed along an arc trajectory to vary the position of the driving rotary shaft.

14. The warning display device for a vehicle according to claim 10, wherein the warning indication part comprises: a laser beam part disposed on the vehicle body to irradiate a warning message along a trajectory set on the panel by an external manipulation; or a remote controller for controlling light-emitting f LED elements disposed on the panel according to the warning message with the set trajectory.
